(19) United States
(12) Patent Application Publication
(10) Pub. No.: US 2018/0012409 A1
(43) Pub. Date: Jan. 11, 2018

(54) PHOTOMETRIC COMPENSATION METHOD AND SYSTEM FOR A SEE-THROUGH DEVICE

(71) Applicant: Himax Technologies Limited, Tainan City (TW)

(72) Inventors: Frank Shyu, Taipei (TW); Jen-Shuo Liu, Taipei (TW); Homer H. Chen, Taipei (TW); Yi-Nung Liu, Tainan City (TW)

(21) Appl. No.: 15/206,840

(22) Filed: Jul. 11, 2016

(51) Int. Cl. G06T 19/00; G02B 27/01; H04N 9/31

(52) U.S. Cl. CPC G06T 19/006; H04N 9/3179; H04N 9/3194; G02B 27/0172; G02B 2027/0118; G02B 2027/0138; G02B 2027/014

(57) ABSTRACT

A photometric compensation for a see-through device is disclosed. A photometric model is provided in which a total response is a sum of a response to a device light from the see-through device and a response to a scene light from a scene. A calibration stage is performed in a transformed domain, which is only related to characteristics of a projector and an image capturing device of the see-through device. A compensation stage is performed to obtain a response for an original image in a dark room, thereby determining a response for a compensated image according to the response for the original image and the response to the scene light. The compensated image is generated according to the response for the compensated image.

### BACKGROUND OF THE INVENTION

### 1. Field of the Invention

The present invention generally relates to photometric compensation, and more particularly to a photometric compensation method and system for see-through devices.

### 2. Description of Related Art

As a tool for augmented reality, see-through smart glasses enable a user to receive additional information about the surrounding real world in the form of image, which is projected from an embedded projector. The user can see both the projected image and the real world scene. Fun and interactive user experiences can be created because the augmented visual information is digitally manipulable.

But the small projectors of most smart glasses have much lower power than traditional projectors. As the projected image is blended with the scene, photometric distortion can easily occur if the projector irradiance is only comparable to, or weaker than, the irradiance of the light coming from the scene and incident on the retina of the user. Such photometric distortion is a major image quality issue of smart glasses.

Although it is the scene light that introduces the photometric distortion, the properties of the scene light, the projector, and the reflectance of smart glasses must be determined if we want to eliminate the photometric distortion. This can be solved by using a camera and a set of calibration patterns. The projector projects images for augmentation or calibration into the user's eye, and the camera is responsible for capturing images of the scene.

However, the approach requires a new round of photometric calibration whenever there is any scene change in the field of view of the smart glasses or whenever the user moves. This may disrupt user interaction. Another issue is efficiency. Projecting and processing the calibration patterns takes time. Typically, the time required for these operations ranges from few seconds to tens of seconds. Obviously, this is not acceptable for real-time applications. A need has thus arisen to propose a novel scheme to overcome disadvantages of the conventional approach.

### SUMMARY OF THE INVENTION

In view of the foregoing, it is an object of the embodiment of the present invention to provide a photometric compensation method and system for see-through devices. In one embodiment, an algorithm capable of photometric compensation based on the distorted image is proposed. It only requires photometric calibration once. Each subsequent compensation operation is based on the distorted image captured at each time instance. Real-time photometric compensation is achieved without re-calibration.

According to one embodiment, a photometric model is provided that a total response is a sum of a response to a device light from the see-through device and a response to a scene light from a scene. A calibration stage is performed in a transformed domain, which is only related to characteristics of a projector and an image capturing device of the see-through device. A compensation stage is performed to obtain a response for an original image in a dark room, thereby determining a response for a compensated image according to the response for the original image and the response to the scene light. The compensated image is generated according to the response for the compensated image.

### BRIEF DESCRIPTION OF THE DRAWINGS

FIG. 1 shows a system block diagram illustrated of a photometric compensation system for see-through devices according to one embodiment of the present invention;

FIG. 2 shows a flow diagram illustrated of a photometric compensation method for see-through devices according to the embodiment of the present invention;

FIG. 3 shows a schematic diagram illustrated of a setup for performing the photometric compensation system of FIG. 1 and the photometric compensation method of FIG. 2 according to the embodiment; and

FIG. 4A and FIG. 4B show exemplary spectral sensitivity of the projector and spectral sensitivity of the camera, respectively.

### DETAILED DESCRIPTION OF THE INVENTION

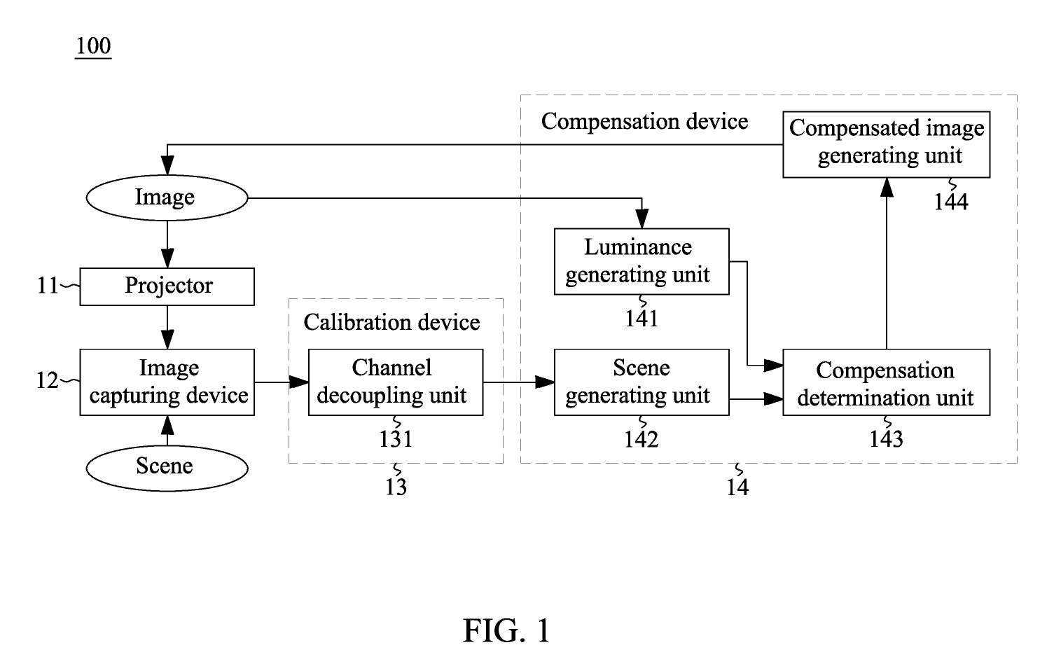

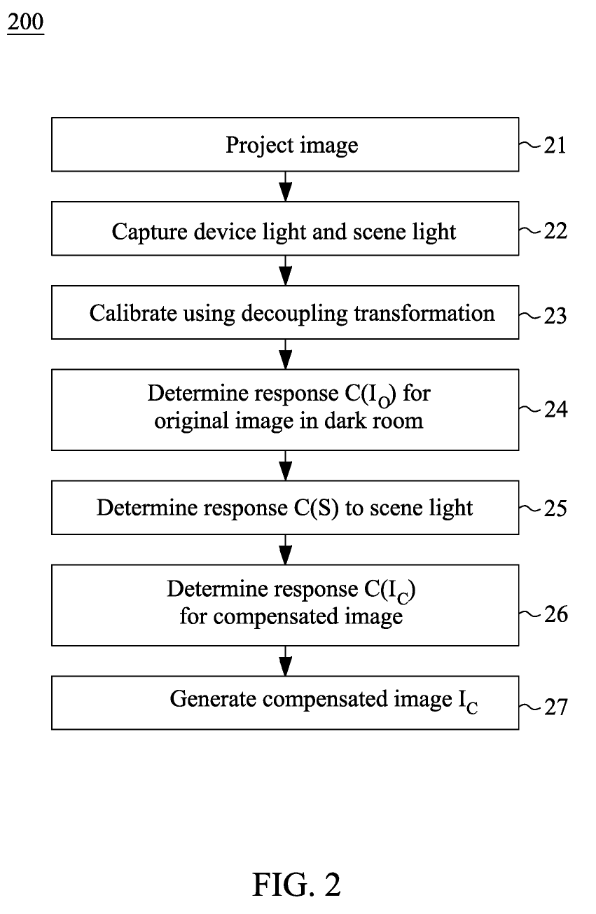

FIG. 1 shows a system block diagram illustrated of a photometric compensation system 100 for see-through devices according to one embodiment of the present invention, and FIG. 2 shows a flow diagram illustrated of a photometric compensation method 200 for see-through devices according to the embodiment of the present invention. Blocks of FIG. 1 and steps of FIG. 2 may be implemented by hardware, software or their combination, and may be performed by a processor such as a digital image processor. The see-through devices may be, but not limited to, wearable see-through devices such as smart glasses.

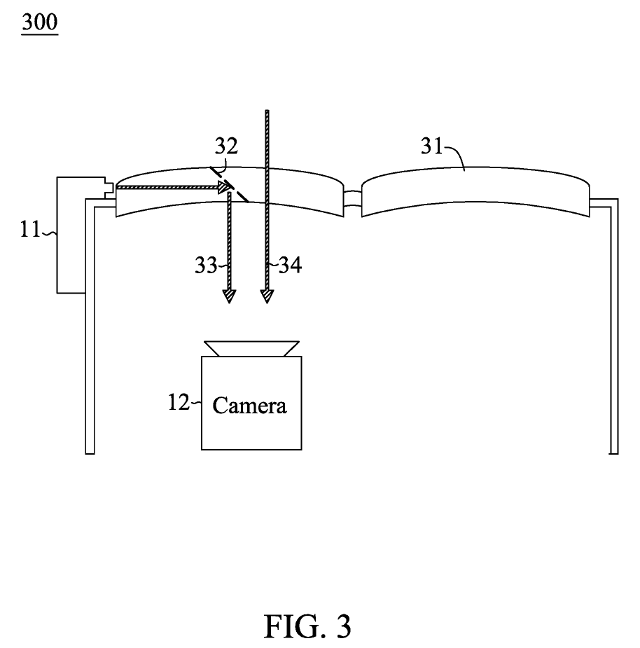

FIG. 3 shows a schematic diagram illustrated of a setup 300 for performing the photometric compensation system 100 (FIG. 1) and the photometric compensation method 200 (FIG. 2) according to the embodiment. The setup 300 includes a projector 11 such as a mini projector that projects an image onto a smart glass 31 via a prism 32 (step 21). An image capturing device 12 such as a camera is used to capture a device light 33 coming from the smart glass 31. The camera 14 also captures a scene light 34 coming from a scene (step 22). The goal of the embodiment is to counteract the effect of the scene light 34 such that the color of the projected image is preserved.

In the embodiment, a photometric model is first provided. Conventional photometric models assume that the scene light either remains constant or is negligible comparing to the device light. However, in the photometric model of the embodiment, both the device light and the scene light have to be considered. The photometric model of the embodiment may be expressed in the vector form as

T(I,S)=C(I)+C(S)=MG(I)+C(S) (1)

where T(I,S) is a total camera response, C(I) is a camera response to the device light, C(S) is a camera response to the scene light, M describes channel mismatch between the projector 11 and the camera 12, and G(•) is a gamma function of the projector 11.

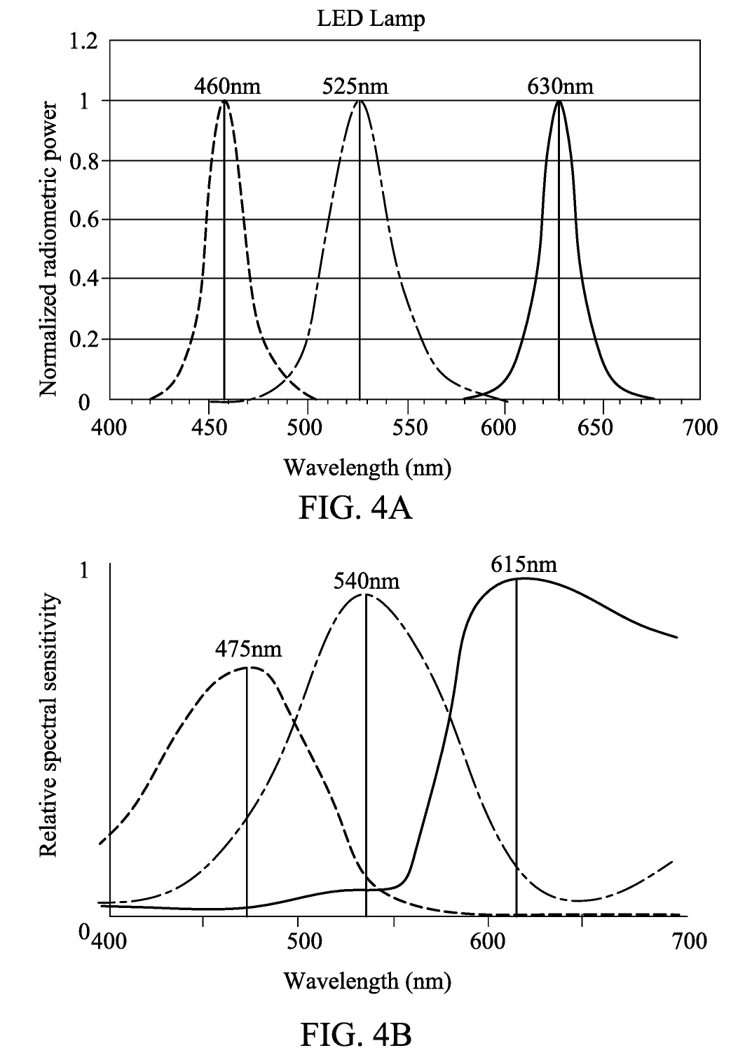

FIG. 4A and FIG. 4B show exemplary spectral sensitivity of the projector 11 and spectral sensitivity of the camera 12, respectively, demonstrating the channel mismatch between the projector 11 and the camera 12.

A calibration stage is performed (in step 23 by a calibration device 13) in a dark room to block the scene light so that we can directly obtain the camera response to the device light. For this camera configuration, (1) becomes

T(I,S)=C(I)=MG(I). (2)

It is generally difficult to solve for M and G(•) directly because the unknowns are coupled. According to one aspect of the embodiment, the calibration stage is performed in a transformed domain by a channel decoupling unit 131 such that (2) can be expressed as

T(I,S)=MG(I)=\tilde{M}V(I) (3)

where \tilde{M} is a decoupling transformation and is only related to the characteristics of the projector 11 and the camera 12, and V(•) is a scaled gamma function.

Note that we convert the problem of determining M and G(•) to that of determining \tilde{M} and V(•). Therefore, it only has to be computed once regardless that the scene or image dynamically changes. To speed up the calibration process, a look up table for V(•) may be constructed.

To be more specific, each channel X of the decoupled camera response \tilde{T}(I,S) can be written as

\tilde{T}_{X}(I,S)=\tilde{C}_{X}(I_{X})=M_{XX}G_{X}(I_{X})≡V_{X}(I_{X}) (4)

where Xε{R, G, B}, Vₓ(•) is defined as the scaled gamma function.

Accordingly, obtaining \tilde{M} and V(•) is equivalent to obtaining M and G(•). Details of solving \tilde{M} may be referred to “Making One Object Look Like Another: Controlling Appearance Using a Projector-Camera System,” entitled to M. D. Grossberg et al., Proc. IEEE CVPR 2004, vol. 1, pp 452-459, 2004, the disclosure of which is incorporated herein by reference.

Subsequently, a photometric compensation stage is performed (by a compensation device 14). Specifically speaking, the total camera response for an original image is

T(I_{O},S)=C(I_{O})+C(S). (5)

The total camera response for a compensated image is

T(I_{C},S)=C(I_{C})+C(S). (6)

In the photometric compensation, it is desired that the total camera response T(I_{C},S) for the compensated image is equal to the camera response C(I_{O}) for the original image in the dark room, that is

T(I_{C},S)=C(I_{C})+C(S)=C(I_{O}). (7)

To obtain C(I_{C}), we need to know C(I_{O}) and C(S). C(I_{O}) is obtained (in step 24 by a luminance generating unit 141) by

C(I_{O})=\tilde{M}V(I). (8)

On the other hand, C(S) can be obtained (in step 25 by a scene generating unit 142) from (5) since T(I_{O},S) and C(I_{O}) are known. Therefore, the camera response C(I_{C}) for the compensated image can be determined according to C(I_{O}) and C(S) (in step 26 by a compensation determination unit 143).

Once \tilde{C} (I_{C}) is obtained, I_{C} is obtained (in step 27 by a compensated image generating unit 144) by

$$\begin{matrix}{I}_{C} = [ \begin{matrix}{V}_{R}^{- 1} ( {\tilde{C}}_{CR} ) \\ {V}_{G}^{- 1} ( {\tilde{C}}_{CG} ) \\ {V}_{B}^{- 1} ( {\tilde{C}}_{CB} )\end{matrix} ] \\ where & ( 9 ) \\ \tilde{C} ( {I}_{C} ) = [ \begin{matrix}{\tilde{C}}_{CR} \\ {\tilde{C}}_{CG} \\ {\tilde{C}}_{CB}\end{matrix} ] = {\tilde{M}}^{- 1} C ( {I}_{C} ) . & ( 10 )\end{matrix}$$

According to the embodiment, a method capable of compensating the photometric distortion for see-through smart glasses is proposed. Since only the distorted image is used in the photometric compensation process, our method does not require re-calibration and hence does not interrupt the user interaction. Accordingly, our method is able to achieve real-time performance for most augmented reality applications using smart glasses. The method works well when the scene light is comparable to the device light in intensity. When the scene light is much weaker, photometric distortion is negligible. On the other hand, when the scene light is much stronger than the device light, it is difficult to restore the image by photometric compensation. In this case, one may either place a “sunglasses” to reduce the scene light or seek a projector with higher power for the smart glasses.

Although specific embodiments have been illustrated and described, it will be appreciated by those skilled in the art that various modifications may be made without departing from the scope of the present invention, which is intended to be limited solely by the appended claims.

1. A photometric compensation method for a see-through device, the method comprising:
providing a photometric model in which a total spectral response is a sum of a spectral response of an image capturing device to a device light from the see-through device and a spectral response of the image capturing device to a scene light from a scene;
performing a calibration stage in a transformed domain, which is only related to characteristics of a projector and the image capturing device of the see-through device;
performing a compensation stage, in which a spectral response for an original image in a dark room is obtained, thereby determining a spectral response for a compensated image according to the spectral response for the original image and the spectral response to the scene light; and
generating the compensated image according to the spectral response for the compensated image;
wherein the spectral response for the compensated image is determined by subtracting the spectral response to the scene light from the spectral response for the original image in the dark room.

2. The method of claim 1, wherein the spectral response to the device light is equal to the product of channel mismatch between the projector and the image capturing device, and a gamma function of the projector.

3. The method of claim 2, wherein the calibration stage is performed in the dark room to block the scene light, thereby obtaining solely the spectral response to the device light.

4. The method of claim 3, wherein the spectral response to the device light is equal to the product of a decoupling transformation and a scaled gamma function.

5. (canceled)

6. A photometric compensation system for a see-through device, the system comprising:
a calibration device that performs a calibration stage in a transformed domain, which is only related to characteristics of a projector and an image capturing device of the see-through device, which provides a photometric model in which a total spectral response is a sum of a spectral response of the image capturing device to a device light from the see-through device and a spectral response of the image capturing device to a scene light from a scene; and
a compensation device that performs a compensation stage, in which a spectral response for an original image in a dark room is obtained, thereby determining a spectral response for a compensated image according to the spectral response for the original image and the spectral response to the scene light;
wherein the compensated image is generated according to the spectral response for the compensated image;
wherein the spectral response for the compensated image is determined by subtracting the spectral response to the scene light from the spectral response for the original image in the dark room.

7. The system of claim 6, wherein the spectral response to the device light is equal to the product of channel mismatch between the projector and the image capturing device, and a gamma function of the projector.

8. The system of claim 7, wherein the calibration stage is performed in the dark room to block the scene light, thereby obtaining solely the spectral response to the device light.

9. The system of claim 8, wherein the spectral response to the device light is equal to the product of a decoupling transformation and a scaled gamma function.

10. The system of claim 9, wherein the calibration stage only has to be performed once regardless that an image to be projected onto the see-through device or the scene dynamically changes.

11. (canceled)

12. The system of claim 6, wherein the compensation device comprises:
a luminance generating unit that generates the spectral response for the original image;
a scene generating unit that generates the spectral response to the scene light subsequent to the calibration stage;
a compensation determination unit that determines the spectral response for the compensated image according to the spectral response for the original image and the spectral response to the scene light; and
a compensated image generating unit that generates the compensated image according to the spectral response for the compensated image.

13. The system of claim 6, wherein the see-through device comprises smart glasses.

14. A see-through device, comprising:
at least one glass;
a projector that projects an image onto the at least one glass;
an image capturing device that captures a device light coming from the at least one glass and a scene light from a scene;
a calibration device that performs a calibration stage in a transformed domain, which is only related to characteristics of the projector and the image capturing device, a photometric model being provided that a total spectral response is a sum of a spectral response of the image capturing device to the device light and a spectral response of the image capturing device to the scene light; and
a compensation device that performs a compensation stage, in which a spectral response for an original image in a dark room is obtained, thereby determining a spectral response for a compensated image according to the spectral response for the original image and the spectral response to the scene light;
wherein the compensated image is generated according to the spectral response for the compensated image;
wherein the spectral response for the compensated image is determined by subtracting the spectral response to the scene light from the spectral response for the original image in the dark room.

15. The see-through device of claim 14, wherein the spectral response to the device light is equal to the product of channel mismatch between the projector and the image capturing device, and a gamma function of the projector.

16. The see-through device of claim 15, wherein the calibration stage is performed in the dark room to block the scene light, thereby obtaining solely the spectral response to the device light.

17. The see-through device of claim 16, wherein the spectral response to the device light is equal to the product of a decoupling transformation and a scaled gamma function.

18. The see-through device of claim 17, wherein the calibration stage only has to be performed once regardless that the image or the scene dynamically changes.

19. (canceled)

20. The see-through device of claim 14, wherein the compensation device comprises:
a luminance generating unit that generates the spectral response for the original image;
a scene generating unit that generates the spectral response to the scene light subsequent to the calibration stage;
a compensation determination unit that determines the spectral response for the compensated image according to the spectral response for the original image and the spectral response to the scene light; and
a compensated image generating unit that generates the compensated image according to the spectral response for the compensated image.
